(19) United States
(12) Patent Application Publication
(10) Pub. No.: US 2014/0267525 A1
(43) Pub. Date: Sep. 18, 2014

(54) Process for coloring gutter designs

(71) Applicant: David J. Evans, Colo Spgs, CO (US)

(72) Inventor: David J. Evans, Colo Spgs, CO (US)

(21) Appl. No.: 13/796,942

(22) Filed: Mar. 12, 2013

(51) Int. Cl. B41M 5/50

(52) U.S. Cl. CPC B41M 5/502
USPC 347/105

(57) ABSTRACT

An embodiment of an applicator wheel, which applies ink to embossed designs on gutters. This is accomplished during manufacturing process of gutter as gutters exit any gutter machine. The embodiment attaches to any gutter machine, and by a simple process applies ink or paint to any design that is raised/embossed. Ink is held in a well, which distributes through a roller to a transfer roller to applicator wheel pad. Two offset rims keep the pad at correct distance from un-embossed portion of gutter and applicator wheel pad paints only the embossed portion of a design. (FIG. 10). Between flexibility of pad and this offset rim distance, ink is applied only to raised/embossed portion of any design by application wheel roller, rolling along the gutter as it exits gutter machine. Another embodiment applies a design directly onto un-embossed gutters. Again, using the applicator wheel, except this embodiment uses a different applicator wheel pad with a design on the pad. (FIG. 11). Different type of ink or paint is used, but easy to find in any color. Thus, designs are directly painted on gutters during manufacturing as gutter exits any gutter machine.

### CROSS REFERENCE TO RELATED APPLICATIONS

(not applicable)

### FEDERALLY SPONSORED RESEARCH

(not applicable)

### SEQUENCE LISTING OR PROGRAM

(not applicable)

### BACKGROUND

This method and device applies color on embossed-designs of gutters. And applies designs on gutters—called hereinafter gutter ink.

### PRIOR ART

Gutter manufacturing industry—when manufacturing seamless gutters—do not apply designs on visible face of gutters. Yet, some manufacturers have attachments for gutter machines that emboss designs on front face of gutters for curb appeal. Even so, viewing from curb of homes, a person cannot perceive these embossed-designs. This method and device—as attachment—applies color (ink, paint or coloring agent) on raised/embossed designs of gutters. Also, this method applies a design—using only a coloring agent or paint—to un-embossed gutters. Gutter machines are not large and available to anyone who wishes to make their own gutters. This method is accomplished during manufacturing process of gutters, as gutter exits any gutter machine.

### Advantages

The gutter industry failed to recognize benefits of designs on gutters. Some manufacturers produce embossing attachments to existing gutter machines, which create designs on seamless gutters. But these manufactures failed to recognize distances which passer-bys could distinguish the embossed designs. The current application solves this problem by applying color (paint, ink or coloring agent) onto embossed portion of gutters. And in another embodiment, applies designs directly on gutters, which are not embossed. Thus, passer-bys can distinguish the designs on home gutters, creating curb appeal for the home.

### SUMMARY

This application shows the designs on seamless gutters, which cannot be seen from street curbs. My device (“gutter ink”) for this application can be fitted onto embossing attachments or directly on gutter machines—or in other embodiments—designs can be painted directly on un-embossed gutters. So, this improves overall effect on a home's appearance. The gutter ink method is a low-tech, high-concept device and process.

### DRAWINGS

Drawing Figures

FIG. 1 shows top view of case of gutter ink device. Also, the figure shows edge of chamber case cover 21 and edge of ink well cover 22. The applicator wheel assy 30 partially extends from the case. The ink well cap 53 attaches to ink well cover 22.

FIG. 2 shows bottom or mounting side of case 20 for the gutter ink. This view shows the bottom, which mounts to any gutter machine. Or mounts onto an embossing machine, which then mounts to a gutter machine. Also, the figure shows edge of chamber case cover 21 and edge of ink well cover 22. The applicator wheel assy 30 partially extends from the case. The ink well cap 53 attaches to ink well cover 22.

FIG. 3 shows side perspective of the case 20 without chamber cover, exposing assemblies in FIGS. 4, 5., and edge of ink well cover 22. Shows partial view of both applicator wheel assy 30 in FIG. 4 and transfer hub assy 40 in FIG. 5.

FIG. 4 shows applicator wheel assembly 30. Drive Shaft 31 drives: gear 33, offset rim 35, drum 34. The applicator roller pad 36 fits over drum 34.

FIG. 5 shows transfer hub assembly 40. Drive shaft 41 drives: gear 43, spacer 47, drum 44, washer 46. The transfer roller pad 45 fits over drum 44.

FIG. 6 shows conceptual view of chamber without cover, exposing applicator wheel assy 30 and transfer hub assy 40, which refers to FIG. 7 on same page.

FIG. 7 shows chamber view without applicator wheel assy 30 and transfer hub assy 40. Slot 37 in case 20, which is inside chamber, and slot 37 on inside of chamber cover 21, holds drive shaft for applicator wheel assy 30. Drive shaft slots 48 inside case 20 chamber and chamber cover 21 hold drive shaft for transfer hub assy 40. Ink roller 50 mounts inside chamber using ink roller mount 51.

FIG. 8 shows ink well 54, which is inside of case 20. Ink well cover 22 holds ink well cap 55. The ink feed hole 54 passes through to chamber in FIG. 7 feeding ink to roller 50 in FIG. 7.

FIG. 9 shows block diagram of gutter ink attaching to gutter embossing attachment, which attaches to gutter machine. Also, shows another configuration of gutter ink attaching directly to gutter machine.

FIG. 10 shows conceptual view of gutter ink case 20 with protruding applicator wheel assy 30 applying ink on embossed 61 portion, which shows edge of gutter 60.

FIG. 11 shows another embodiment of the applicator wheel assy 30 and roller pad 36 with a design on the pad itself.

### REFERENCE NUMERALS

| | |
|---|---|
| 20 | Case |
| 21 | Chamber Cover |
| 22 | Ink Well Cover |
| 23 | Chamber |
| 30 | Applicator Wheel Assy. |
| 31 | Drive Shaft |
| 32 | Drive Shaft Slot |
| 33 | Gear |
| 34 | Drum w/Offset Rim |
| 35 | Offset Rim |
| 36 | Applicator Roller Pad |
| 37 | Drive Shaft Slot |
| 38 | Offset Rim w/Drum |
| 39 | Pre-Design Roller Pad |
| 40 | Transfer Hub Assy. |
| 41 | Drive Shaft |
| 42 | Drive Shaft Slot |
| 43 | Gear |
| 44 | Drum |
| 45 | Transfer Roller Pad |
| 46 | Washer |
| 47 | Spacer |
| 48 | Drive Shaft Slot |
| 50 | Ink Roller |
| 51 | Ink Roller Mount |
| 52 | Ink Roller Mounting Hole |
| 53 | Ink well |
| 54 | Ink Feed Hole |
| 55 | Ink Well Cap |
| 60 | Gutter |
| 61 | Raised Emboss on Gutter |

### DETAILED DESCRIPTION

### Description

### FIGS. 1-10

The gutter ink device is contained by case shown in FIG. 1, 2. The case mounting side attaches to any gutter machine with minimal adaptation. As the gutter is produced and fed from gutter machines, FIG. 10 shows the applicator wheel 30 rolling along the gutter. The applicator wheel assembly FIG. 4 has two offset rims 35, 38 that can be interchanged—based on height of embossed designs—and rides along outer sides of embossed designs 60. The applicator wheel assembly 30, FIG. 4, uses drum 34 covered by roller pad 36. A gear 43 is outer side with drive shaft 41 driving applicator wheel assembly. Slots 37 in FIG. 7 are inside chamber of case 20 and inside chamber cover 21.

The transfer hub assembly 40 in FIG. 5 uses gear 43 on outer side. Drive shaft 41 drives transfer hub assembly. Fitted over the drum 44 is ink transfer pad 45. Slots 48 in FIG. 7 are located in chamber of case 20 and chamber cover 21, which retains drive shaft 41, FIG. 5.

Ink (coloring agent) is held in ink well 53 in FIG. 8. A threaded cap 53 screws into ink well cover 22. The ink roller 50 in FIG. 7 mounts inside chamber 23. Ink is fed through hole 54 into chamber 23 in FIG. 6, 7.

### Operation

### First Embodiment—FIGS. 4, 5, 7, 9, 10

The applicator wheel assembly 30 in FIG. 4 uses gear 33 to drive transfer hub assembly 40, FIG. 5. This gear meshes with transfer hub gear 43. Ink is feed from ink well 53 in FIG. 8 through hole 54 to ink roller 50, FIG. 7, which is in chamber 23, FIG. 7. Ink roller 51 distributes ink onto transfer roller pad 45, FIG. 5. Next, transfer hub pad transfers ink to applicator wheel roller pad 36, FIG. 4. Gutter ink device is mounted on any gutter machine, and as the gutter leaves machine—after embossed in FIG. 9 by any gutter machine—the gutter ink applicator wheel assembly 30 in FIG. 4 distributes ink to the embossed/raised design 61 in FIG. 10. The applicator wheel offset rims 35, 38, FIG. 4, travel on gutter, as gutter slowly leaves the gutter machine FIGS. 9 and 35, 38, FIG. 10. As applicator wheel turns, ink is feed from ink well 53 FIG. 8 to ink roller 50 FIG. 7 to transfer hub 40 FIG. 3 to applicator wheel 30, and then distributed by applicator roller pad 36, FIG. 4, to raised/embossed portions of designs 61, FIG. 10. Between applicator wheel offset rims 35, 38 in FIG. 4 and flexibility of pad 36 the ink is only distributed on embossed designs 61 and not outside of embossed designs 60 shown in FIG. 10.

### Description

### Additional Embodiment—FIGS. 5, 9, 11

Incorporate previous description here, except: change applicator wheel pad 36, FIG. 4, with a pre-design pad 39, FIG. 11.

### Operation

### Additional Embodiment—FIGS. 4, 9, 11

After changing applicator roller pad 36, FIG. 4, with pre-design pad 39, FIG. 11, designs are directly painted on un-embossed gutters while exiting any gutter machine FIG. 9 (bottom). A different coloring agent (something between a paint and glue) is used to apply designs from pad to gutter.

### CONCLUSION, RAMIFICATIONS, AND SCOPE

The gutter ink process and device improve the look of gutters. Instead of plain, boring gutters on a home, this process adds value to homes. And the gutter manufacturers do not recognize this. Gutter ink is a simple and easy way to attach to any gutter machine. It takes little set-up time and improves the visible appeal of gutters. In the second embodiment, all that's needed is a change of roller pad and a different coloring agent, easily available in many different colors.

### Sequence Listing

(not applicable)

1. A method for applying designs onto gutters, compromising:
a. providing color to embossed said designs, and
b. applying color as said designs
whereby said gutters depict said designs.
